(19) United States
(12) Patent Application Publication
(10) Pub. No.: US 2020/0353884 A1
(43) Pub. Date: Nov. 12, 2020

(54) SYSTEM ON CHIP

(71) Applicant: Mobileye Vision Technologies Ltd., Jerusalem (IL)

(72) Inventors: Simone Fabris, Tel Aviv (IL); Efim Belman, Jerusalem (IL); Efraim Mangell, Jerusalem (IL)

(21) Appl. No.: 16/869,681

(22) Filed: May 8, 2020

Related U.S. Application Data
(60) Provisional application No. 62/844,739, filed on May 8, 2019.

(51) Int. Cl. B60R 21/01; G05D 1/00

(52) U.S. Cl. CPC B60R 21/01; B60R 2021/01259; G05D 1/0088

(57) ABSTRACT

A system on chip that comprises independent paths that applies ASIL decomposition in order to comply with an ASIL level.

### CROSS REFERENCE

This application claims priority from U.S. Provisional Application No. 62/844,739, filed May 8, 2019, which is incorporated herein by reference.

### BACKGROUND

Electronic Control Units (ECUs) have been used for many years in safety critical applications in different domains (e.g., medical, automotive, etc.). The traditional ECU may have one or more processors, but each processor executed a single application. This is true even for advanced ECUs where multiple instances of a single application ran on a multicore central processing unit (CPU). In this model the different functions of the system are integrated into a single application. Resource allocation is performed statically by the integrator.

The traditional approach to the hardware and software of ECUs is changing. Modern ECUs use advanced systems on chips (SOCs) that may include multicore central processing units and accelerators. Modern ECUs can run multiple and diverse applications. For example, a single SOC can run computer vision tasks on sensor input and also calculate a trajectory.

Vehicle components should be compliant to a certain Automotive Safety Integrity Level (ASIL) specification.

Modern ECUs for automotive applications (for example, automated driving) and that have authority over vehicle dynamics (longitudinal and lateral) shall meet the highest safety integrity available within the industry. This is currently set to the ASIL-D level according to ISO26262:2018.

In order to meet such safety integrity requirement as well as improving the overall system reliability, a standard approach from automotive original equipment manufacturers (OEMs) and Tierl vendors is to rely on “ASIL decomposition”.

According to this approach, the same ASIL-D requirement can be implemented by two redundant systems, each one developed according to ASIL-B(D) integrity. The reference (D) indicates that an ASIL decomposition is applied.

Considering the increased digitalization of in-vehicle electronics and availability of cheap and reliable systems on chip (SOCs), a standard approach taken by OEMs and Tierl vendors in order to show “evidence for sufficient independence between decomposed elements” is to populate the ECU with two different SOCs sourced by different vendors, each SOC running the same functionality. When using two different SOCs, any potential dependent failure that can affect the first SOC is supposed not to manifest itself in the same way in the second SOC. The outputs of both the different SOCs are ASIL-B(D) compliant and their outputs are fed to a comparator that is ASIL-D compliant. The comparator compares between the outputs and sends a selected output to an actuator. The comparator may be located outside the ECU.

Thus, prior art solutions included undergoing dedicated SOC development, SOC diversity (populating the ECU with SOCs from different vendors, mixing technologies), mounting ECUs with diverse hardware architecture in the target vehicle (e.g. a first ECU from a Tierl-A vendor, and a second ECU from Tierl-B vendor), each one implementing the same functionality.

These solutions exhibit a high cost for the final user (impossibility to scale with a single supplier), high development cost (need to maintain one development platform per SOC), high data logging costs (one data logging platform required per each SOC), and increased manufacturing complexity (unless the different SOC are implemented in different ECUs—in which case the overall cost will be even higher).

### SUMMARY

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description may not be limited to the disclosed embodiments and examples.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram representation of a system consistent with the disclosed embodiments;

FIG. 2A is a diagrammatic side view representation of an exemplary vehicle including a system consistent with the disclosed embodiments;

FIG. 2B is a diagrammatic top view representation of the vehicle and system shown in FIG. 2A consistent with the disclosed embodiments;

FIG. 2C is a diagrammatic top view representation of another embodiment of a vehicle including a system consistent with the disclosed embodiments;

FIG. 2D is a diagrammatic top view representation of yet another embodiment of a vehicle including a system consistent with the disclosed embodiments;

FIG. 2E is a diagrammatic representation of exemplary vehicle control systems consistent with the disclosed embodiments;

FIG. 3 is a diagrammatic representation of an interior of a vehicle including a rearview mirror and a user interface for a vehicle imaging system consistent with the disclosed embodiments;

FIG. 4 illustrates an example of an SOC;

FIG. 5 illustrates an example of an SOC;

FIG. 6 illustrates an example of a various fault reduction measures; and

FIG. 7 illustrates an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system.

Before discussing in detail examples of features of the processing images of an environment ahead of a vehicle navigating a road for training a neural networks or deep learning algorithms to estimate a future path of a vehicle based on images or feature of the processing of images of an environment ahead of a vehicle navigating a road using a trained neural network to estimate a future path of the vehicle, there is provided a description of various possible implementations and configurations of a vehicle mountable system that can be used for carrying out and implementing the methods according to examples of the presently disclosed subject matter. In some embodiments, various examples of the system can be mounted in a vehicle, and can be operated while the vehicle is in motion. In some embodiments, the system can implement the methods according to examples of the presently disclosed subject matter.

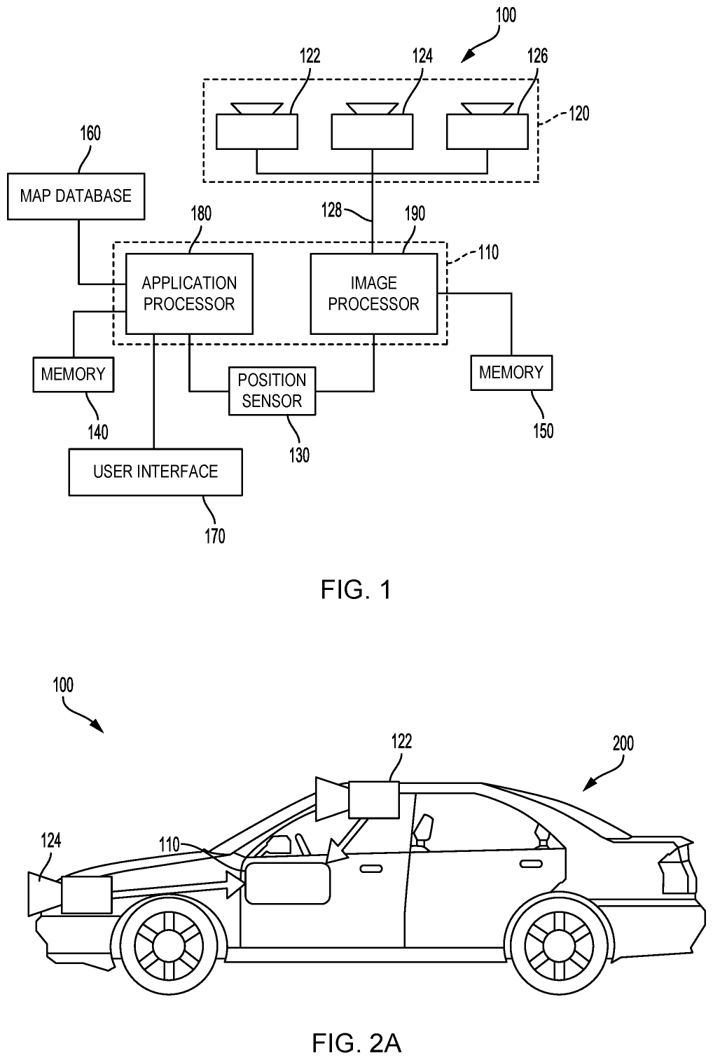

FIG. 1, to which reference is now made, is a block diagram representation of a system consistent with the disclosed embodiments. System 100 can include various components depending on the requirements of a particular implementation. In some examples, system 100 can include a processing unit 110, an image acquisition unit 120 and one or more memory units 140, 150. Processing unit 110 can include one or more processing devices. In some embodiments, processing unit 110 can include an application processor 180, an image processor 190, or any other suitable processing device. Similarly, image acquisition unit 120 can include any number of image acquisition devices and components depending on the requirements of a particular application. In some embodiments, image acquisition unit 120 can include one or more image capture devices (e.g., cameras), such as image capture device 122, image capture device 124, and image capture device 126. In some embodiments, system 100 can also include a data interface 128 communicatively connecting processing unit 110 to image acquisition device 120. For example, data interface 128 can include any wired and/or wireless link or links for transmitting image data acquired by image acquisition device 120 to processing unit 110.

Both application processor 180 and image processor 190 can include various types of processing devices. For example, either or both of application processor 180 and image processor 190 can include one or more microprocessors, preprocessors (such as image preprocessors), graphics processors, central processing units (CPUs), support circuits, digital signal processors, integrated circuits, memory, or any other types of devices suitable for running applications and for image processing and analysis. In some embodiments, application processor 180 and/or image processor 190 can include any type of single or multi-core processor, mobile device microcontroller, central processing unit, etc. Various processing devices can be used, including, for example, processors available from manufacturers such as Intel®, AMD®, etc. and can include various architectures (e.g., x86 processor, ARM®, etc.).

In some embodiments, application processor 180 and/or image processor 190 can include any of the EyeQ series of processor chips available from Mobileye®. These processor designs each include multiple processing units with local memory and instruction sets. Such processors may include video inputs for receiving image data from multiple image sensors and may also include video out capabilities. In one example, the EyeQ2® uses 90 nm-micron technology operating at 332 Mhz. The EyeQ2® architecture has two floating point, hyper-thread 32-bit RISC CPUs (MIPS32® 34K® cores), five Vision Computing Engines (VCE), three Vector Microcode Processors (VMP®), Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMP®, and the DMA, the second MIPS34K CPU and the multi-channel DMA as well as the other peripherals. The five VCEs, three VMP® and the MIPS34K CPU can perform intensive vision computations required by multi-function bundle applications. In another example, the EyeQ3®, which is a third-generation processor and is six times more powerful that the EyeQ2®, may be used in the disclosed examples. In yet another example, the EyeQ4®, the fourth-generation processor or any further generation chip, may be used in the disclosed examples.

While FIG. 1 depicts two separate processing devices included in processing unit 110, more or fewer processing devices can be used. For example, in some examples, a single processing device may be used to accomplish the tasks of application processor 180 and image processor 190. In other embodiments, these tasks can be performed by more than two processing devices.

Processing unit 110 can include various types of devices. For example, processing unit 110 may include various devices, such as a controller, an image preprocessor, a central processing unit (CPU), support circuits, digital signal processors, integrated circuits, memory, or any other types of devices for image processing and analysis. The image preprocessor can include a video processor for capturing, digitizing and processing the imagery from the image sensors. The CPU can include any number of microcontrollers or microprocessors. The support circuits can be any number of circuits generally well known in the art, including cache, power supply, clock and input-output circuits. The memory can store software that, when executed by the processor, controls the operation of the system. The memory can include databases and image processing software, including a trained system, such as a neural network, for example. The memory can include any number of random access memories, read only memories, flash memories, disk drives, optical storage, removable storage and other types of storage. In one instance, the memory can be separate from the processing unit 110. In another instance, the memory can be integrated into the processing unit 110.

Each memory 140, 150 can include software instructions that when executed by a processor (e.g., application processor 180 and/or image processor 190), can control operation of various aspects of system 100. These memory units can include various databases and image processing software. The memory units can include random access memory, read only memory, flash memory, disk drives, optical storage, tape storage, removable storage and/or any other types of storage. In some examples, memory units 140, 150 can be separate from the application processor 180 and/or image processor 190. In other embodiments, these memory units can be integrated into application processor 180 and/or image processor 190.

In some embodiments, the system can include a position sensor 130. The position sensor 130 can include any type of device suitable for determining a location associated with at least one component of system 100. In some embodiments, position sensor 130 can include a GPS receiver. Such receivers can determine a user position and velocity by processing signals broadcasted by global positioning system satellites. Position information from position sensor 130 can be made available to application processor 180 and/or image processor 190.

In some embodiments, the system 100 can be operatively connectible to various systems, devices and units onboard a vehicle in which the system 100 can be mounted, and through any suitable interfaces (e.g., a communication bus) the system 100 can communicate with the vehicle's systems. Examples of vehicle systems with which the system 100 can cooperate include: a throttling system, a braking system, and a steering system.

In some embodiments, the system 100 can include a user interface 170. User interface 170 can include any device suitable for providing information to or for receiving inputs from one or more users of system 100, including, for example, a touchscreen, microphone, keyboard, pointer devices, track wheels, cameras, knobs, buttons, etc. Information can be provided by the system 100, through the user interface 170, to the user.

In some embodiments, the system 100 can include a map database 160. The map database 160 can include any type of database for storing digital map data. In some examples, map database 160 can include data relating to a position, in a reference coordinate system, of various items, including roads, water features, geographic features, points of interest, etc. Map database 160 can store not only the locations of such items, but also descriptors relating to those items, including, for example, names associated with any of the stored features and other information about them. For example, locations and types of known obstacles can be included in the database, information about a topography of a road or a grade of certain points along a road, etc. In some embodiments, map database 160 can be physically located with other components of system 100. Alternatively, or additionally, map database 160 or a portion thereof can be located remotely with respect to other components of system 100 (e.g., processing unit 110). In such embodiments, information from map database 160 can be downloaded over a wired or wireless data connection to a network (e.g., over a cellular network and/or the Internet, etc.).

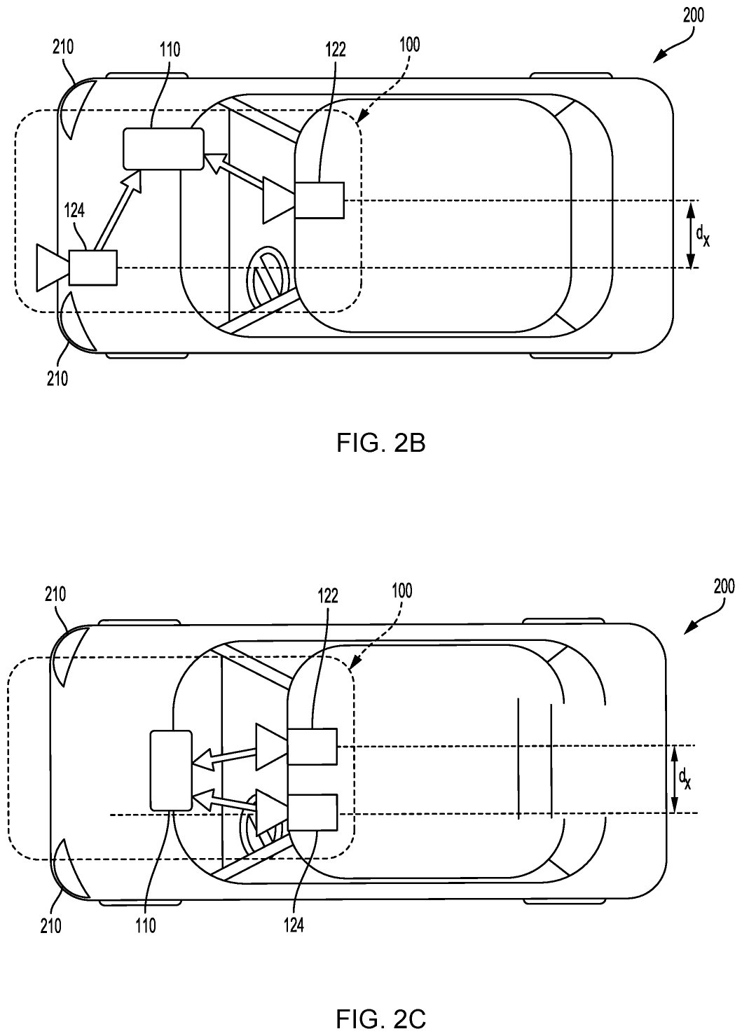

Image capture devices 122, 124, and 126 can each include any type of device suitable for capturing at least one image from an environment. Moreover, any number of image capture devices can be used to acquire images for input to the image processor. Some examples of the presently disclosed subject matter can include or can be implemented with only a single-image capture device, while other examples can include or can be implemented with two, three, or even four or more image capture devices. Image capture devices 122, 124, and 126 will be further described with reference to FIGS. 2A-2E, below.

It would be appreciated that the system 100 can include or can be operatively associated with other types of sensors, including for example: an acoustic sensor, a RF sensor (e.g., radar transceiver), a LIDAR sensor. Such sensors can be used independently of or in cooperation with the image acquisition device 120. For example, the data from the radar system (not shown) can be used for validating the processed information that is received from processing images acquired by the image acquisition device 120, e.g., to filter certain false positives resulting from processing images acquired by the image acquisition device 120, or it can be combined with or otherwise compliment the image data from the image acquisition device 120, or some processed variation or derivative of the image data from the image acquisition device 120.

System 100, or various components thereof, can be incorporated into various different platforms. In some embodiments, system 100 may be included on a vehicle 200, as shown in FIG. 2A. For example, vehicle 200 can be equipped with a processing unit 110 and any of the other components of system 100, as described above relative to FIG. 1. While in some embodiments vehicle 200 can be equipped with only a single-image capture device (e.g., camera), in other embodiments, such as those discussed in connection with FIGS. 2B-2E, multiple image capture devices can be used. For example, either of image capture devices 122 and 124 of vehicle 200, as shown in FIG. 2A, can be part of an ADAS (Advanced Driver Assistance Systems) imaging set.

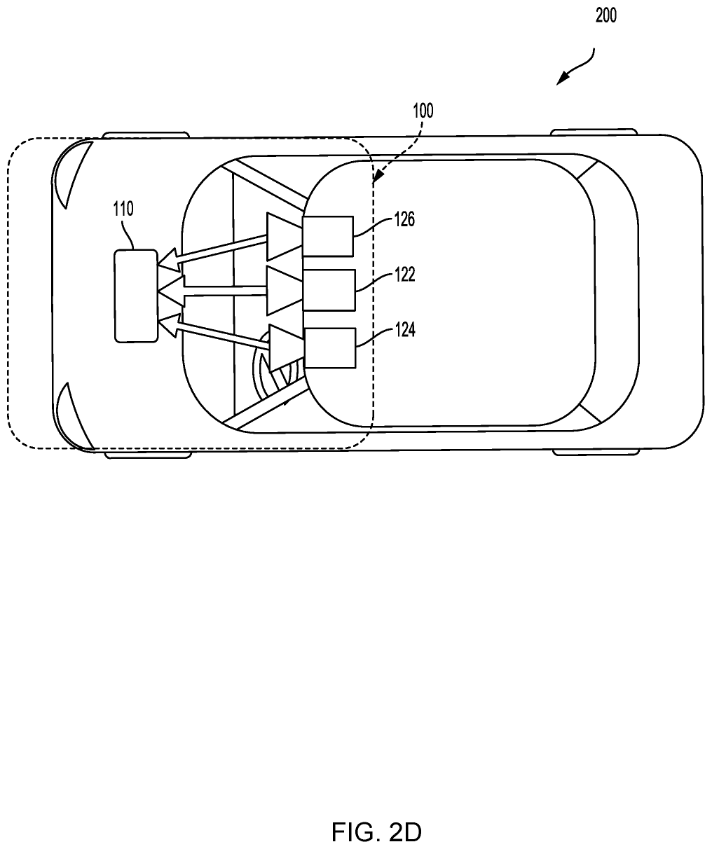

The image capture devices included on vehicle 200 as part of the image acquisition unit 120 can be positioned at any suitable location. In some embodiments, as shown in FIGS. 2A-2E and 3, image capture device 122 can be located in the vicinity of the rearview mirror. This position may provide a line of sight similar to that of the driver of vehicle 200, which can aid in determining what is and is not visible to the driver.

Other locations for the image capture devices of image acquisition unit 120 can also be used. For example, image capture device 124 can be located on or in a bumper of vehicle 200. Such a location can be especially suitable for image capture devices having a wide field of view. The line of sight of bumper-located image capture devices can be different from that of the driver. The image capture devices (e.g., image capture devices 122, 124, and 126) can also be located in other locations. For example, the image capture devices may be located on or in one or both of the side mirrors of vehicle 200, on the roof of vehicle 200, on the hood of vehicle 200, on the trunk of vehicle 200, on the sides of vehicle 200, mounted on, positioned behind, or positioned in front of any of the windows of vehicle 200, and mounted in or near light figures on the front and/or back of vehicle 200, etc. The image capture unit 120, or an image capture device that is one of a plurality of image capture devices that are used in an image capture unit 120, can have a field-of-view (FOV) that is different than the FOV of a driver of a vehicle, and not always see the same objects. In one example, the FOV of the image acquisition unit 120 can extend beyond the FOV of a typical driver and can thus image objects which are outside the FOV of the driver. In yet another example, the FOV of the image acquisition unit 120 is some portion of the FOV of the driver. In some embodiments, the FOV of the image acquisition unit 120 corresponds to a sector which covers an area of a road ahead of a vehicle and possibly also surroundings of the road.

In addition to image capture devices, vehicle 200 can be include various other components of system 100. For example, processing unit 110 may be included on vehicle 200 either integrated with or separate from an engine control unit of the vehicle. Vehicle 200 may also be equipped with a position sensor 130, such as a GPS receiver and may also include a map database 160 and memory units 140 and 150.

FIG. 2A is a diagrammatic side view representation of a vehicle imaging system according to examples of the presently disclosed subject matter. FIG. 2B is a diagrammatic top view illustration of the example shown in FIG. 2A. As illustrated in FIG.2B, the disclosed examples can include a vehicle 200 including in its body a system 100 with a first image capture device 122 positioned in the vicinity of the rearview mirror and/or near the driver of vehicle 200, a second image capture device 124 positioned on or in a bumper region (e.g., one of bumper regions 210) of vehicle 200, and a processing unit 110.

As illustrated in FIG.2C, image capture devices 122 and 124 may both be positioned in the vicinity of the rearview mirror and/or near the driver of vehicle 200. Additionally, while two image capture devices 122 and 124 are shown in FIG.2B and 2C, it should be understood that other embodiments may include more than two image capture devices. For example, in the embodiment shown in FIG.2D, first, second, and third image capture devices 122, 124, and 126, are included in the system 100 of vehicle 200.

As shown in FIG.2D, image capture devices 122, 124, and 126 may be positioned in the vicinity of the rearview mirror and/or near the driver seat of vehicle 200. The disclosed examples are not limited to any particular number and configuration of the image capture devices, and the image capture devices may be positioned in any appropriate location within and/or on vehicle 200.

It is also to be understood that disclosed embodiments are not limited to a particular type of vehicle 200 and may be applicable to all types of vehicles including automobiles, trucks, trailers, motorcycles, bicycles, self-balancing transport devices and other types of vehicles.

The first image capture device 122 can include any suitable type of image capture device. Image capture device 122 can include an optical axis. In one instance, the image capture device 122 can include an Aptina M9V024 WVGA sensor with a global shutter. In another example, a rolling shutter sensor can be used. Image acquisition unit 120, and any image capture device which is implemented as part of the image acquisition unit 120, can have any desired image resolution. For example, image capture device 122 can provide a resolution of 1280×960 pixels and can include a rolling shutter.

Image acquisition unit 120, and any image capture device which is implemented as part of the image acquisition unit 120, can include various optical elements. In some embodiments one or more lenses can be included, for example, to provide a desired focal length and field of view for the image acquisition unit 120, and for any image capture device which is implemented as part of the image acquisition unit 120. In some examples, an image capture device which is implemented as part of the image acquisition unit 120 can include or be associated with any optical elements, such as a 6 mm lens or a 12 mm lens, for example. In some examples, image capture device 122 can be configured to capture images having a desired (and known) field-of-view (FOV).

The first image capture device 122 may have a scan rate associated with acquisition of each of the first series of image scan lines. The scan rate may refer to a rate at which an image sensor can acquire image data associated with each pixel included in a particular scan line.

FIG.2E is a diagrammatic representation of vehicle control systems, according to examples of the presently disclosed subject matter. As indicated in fi FIG. 2E, vehicle 200 can include throttling system 220, braking system 230, and steering system 240. System 100 can provide inputs (e.g., control signals) to one or more of throttling system 220, braking system 230, and steering system 240 over one or more data links (e.g., any wired and/or wireless link or links for transmitting data). For example, based on analysis of images acquired by image capture devices 122, 124, and/or 126, system 100 can provide control signals to one or more of throttling system 220, braking system 230, and steering system 240 to navigate vehicle 200 (e.g., by causing an acceleration, a turn, a lane shift, etc.). Further, system 100 can receive inputs from one or more of throttling system 220, braking system 230, and steering system 240 indicating operating conditions of vehicle 200 (e.g., speed, whether vehicle 200 is braking and/or turning, etc.).

As shown in FIG. 3, vehicle 200 may also include a user interface 170 for interacting with a driver or a passenger of vehicle 200. For example, user interface 170 in a vehicle application may include a touch screen 320, knobs 330, buttons 340, and a microphone 350. A driver or passenger of vehicle 200 may also use handles (e.g., located on or near the steering column of vehicle 200 including, for example, turn signal handles), buttons (e.g., located on the steering wheel of vehicle 200), and the like, to interact with system 100. In some embodiments, microphone 350 may be positioned adjacent to a rearview mirror 310. Similarly, in some embodiments, image capture device 122 may be located near rearview mirror 310. In some embodiments, user interface 170 may also include one or more speakers 360 (e.g., speakers of a vehicle audio system). For example, system 100 may provide various notifications (e.g., alerts) via speakers 360.

As will be appreciated by a person skilled in the art having the benefit of this disclosure, numerous variations and/or modifications may be made to the foregoing disclosed embodiments. For example, not all components are essential for the operation of system 100. Further, any component may be located in any appropriate part of system 100 and the components may be rearranged into a variety of configurations while providing the functionality of the disclosed embodiments. Therefore, the foregoing configurations are examples and, regardless of the configurations discussed above, system 100 can provide a wide range of functionality to analyze the surroundings of vehicle 200 and, in response to this analysis, navigate and/or otherwise control and/or operate vehicle 200. Navigation, control, and/or operation of vehicle 200 may include enabling and/or disabling (directly or via intermediary controllers, such as the controllers mentioned above) various features, components, devices, modes, systems, and/or subsystems associated with vehicle 200. Navigation, control, and/or operation may alternately or additionally include interaction with a user, driver, passenger, passerby, and/or other vehicle or user, which may be located inside or outside vehicle 200, for example by providing visual, audio, haptic, and/or other sensory alerts and/or indications.

As discussed below in further detail and consistent with various disclosed embodiments, system 100 may provide a variety of features related to autonomous driving, semi-autonomous driving and/or driver assist technology. For example, system 100 may analyze image data, position data (e.g., GPS location information), map data, speed data, and/or data from sensors included in vehicle 200. System 100 may collect the data for analysis from, for example, image acquisition unit 120, position sensor 130, and other sensors. Further, system 100 may analyze the collected data to determine whether or not vehicle 200 should take a certain action, and then automatically take the determined action without human intervention. It would be appreciated that in some cases, the actions taken automatically by the vehicle are under human supervision, and the ability of the human to intervene adjust abort or override the machine action is enabled under certain circumstances or at all times. For example, when vehicle 200 navigates without human intervention, system 100 may automatically control the braking, acceleration, and/or steering of vehicle 200 (e.g., by sending control signals to one or more of throttling system 220, braking system 230, and steering system 240). Further, system 100 may analyze the collected data and issue warnings, indications, recommendations, alerts, or instructions to a driver, passenger, user, or other person inside or outside of the vehicle (or to other vehicles) based on the analysis of the collected data. Additional details regarding the various embodiments that are provided by system 100 are provided below.

Multi-Imaging System

As discussed above, system 100 may provide drive assist functionality or semi or fully autonomous driving functionality that uses a single or a multi-camera system. The multi-camera system may use one or more cameras facing in the forward direction of a vehicle. In other embodiments, the multi-camera system may include one or more cameras facing to the side of a vehicle or to the rear of the vehicle. In one embodiment, for example, system 100 may use a two-camera imaging system, where a first camera and a second camera (e.g., image capture devices 122 and 124) may be positioned at the front and/or the sides of a vehicle (e.g., vehicle 200). The first camera may have a field of view that is greater than, less than, or partially overlapping with, the field of view of the second camera. In addition, the first camera may be connected to a first image processor to perform monocular image analysis of images provided by the first camera, and the second camera may be connected to a second image processor to perform monocular image analysis of images provided by the second camera. The outputs (e.g., processed information) of the first and second image processors may be combined. In some embodiments, the second image processor may receive images from both the first camera and second camera to perform stereo analysis. In another embodiment, system 100 may use a three-camera imaging system where each of the cameras has a different field of view. Such a system may, therefore, make decisions based on information derived from objects located at varying distances both forward and to the sides of the vehicle. References to monocular image analysis may refer to instances where image analysis is performed based on images captured from a single point of view (e.g., from a single camera). Stereo image analysis may refer to instances where image analysis is performed based on two or more images captured with one or more variations of an image capture parameter. For example, captured images suitable for performing stereo image analysis may include images captured: from two or more different positions, from different fields of view, using different focal lengths, along with parallax information, etc.

For example, in one embodiment, system 100 may implement a three-camera configuration using image capture devices 122-126. In such a configuration, image capture device 122 may provide a narrow field of view (e.g., 34 degrees, or other values selected from a range of about 20 to 45 degrees, etc.), image capture device 124 may provide a wide field of view (e.g., 150 degrees or other values selected from a range of about 100 to about 180 degrees), and image capture device 126 may provide an intermediate field of view (e.g., 46 degrees or other values selected from a range of about 35 to about 60 degrees). In some embodiments, image capture device 126 may act as a main or primary camera. Image capture devices 122-126 may be positioned behind rearview mirror 310 and positioned substantially side-by-side (e.g., 6 cm apart). Further, in some embodiments, one or more of image capture devices 122-126 may be mounted behind glare shield that is flush with the windshield of vehicle 200. Such shielding may act to minimize the impact of any reflections from inside the car on image capture devices 122-126.

In another embodiment, the wide field of view camera (e.g., image capture device 124 in the above example) may be mounted lower than the narrow and main field of view cameras (e.g., image devices 122 and 126 in the above example). This configuration may provide a free line of sight from the wide field of view camera. To reduce reflections, the cameras may be mounted close to the windshield of vehicle 200, and may include polarizers on the cameras to damp reflected light.

A three-camera system may provide certain performance characteristics. For example, some embodiments may include an ability to validate the detection of objects by one camera based on detection results from another camera. In the three-camera configuration discussed above, processing unit 110 may include, for example, three processing devices (e.g., three EyeQ series of processor chips, as discussed above), with each processing device dedicated to processing images captured by one or more of image capture devices 122-126.

In a three-camera system, a first processing device may receive images from both the main camera and the narrow field of view camera, and perform processing of the narrow field of view (FOV) camera or even a cropped FOV of the camera. In some embodiments, the first processing device can be configured to use a trained system (e.g., a trained neural network) to detect objects and/or road features (commonly referred to as “road objects”), predict a vehicle's path, etc. ahead of a current location of a vehicle.

The first processing device can be further adapted to preform image processing tasks, for example, which can be intended to detect other vehicles, pedestrians, lane marks, traffic signs, traffic lights, and other road objects. Still further, the first processing device may calculate a disparity of pixels between the images from the main camera and the narrow camera and create a three-dimensional (3D) reconstruction of the environment of vehicle 200. The first processing device may then combine the 3D reconstruction with 3D map data (e.g., a depth map) or with 3D information calculated based on information from another camera. In some embodiments, the first processing device can be configured to use the trained system on depth information (for example the 3D map data), in accordance with examples of the presently disclosed subject matter. In this implementation the system can be trained on depth information, such as 3D map data.

The second processing device may receive images from main camera and can be configured to perform vision processing to detect other vehicles, pedestrians, lane marks, traffic signs, traffic lights, road barriers, debris and other road objects. Additionally, the second processing device may calculate a camera displacement and, based on the displacement, calculate a disparity of pixels between successive images and create a 3D reconstruction of the scene (e.g., a structure from motion). The second processing device may send the structure from motion-based 3D reconstruction to the first processing device to be combined with the stereo 3D images or with the depth information obtained by stereo processing.

The third processing device may receive images from the wide FOV camera and process the images to detect vehicles, pedestrians, lane marks, traffic signs, traffic lights, and other road objects. The third processing device may execute additional processing instructions to analyze images to identify objects moving in the image, such as vehicles changing lanes, pedestrians, etc.

In some embodiments, having streams of image-based information captured and processed independently may provide an opportunity for providing redundancy in the system. Such redundancy may include, for example, using a first image capture device and the images processed from that device to validate and/or supplement information obtained by capturing and processing image information from at least a second image capture device.

In some embodiments, system 100 may use two image capture devices (e.g., image capture devices 122 and 124) in providing navigation assistance for vehicle 200 and use a third image capture device (e.g., image capture device 126) to provide redundancy and validate the analysis of data received from the other two image capture devices. For example, in such a configuration, image capture devices 122 and 124 may provide images for stereo analysis by system 100 for navigating vehicle 200, while image capture device 126 may provide images for monocular analysis by system 100 to provide redundancy and validation of information obtained based on images captured from image capture device 122 and/or image capture device 124. That is, image capture device 126 (and a corresponding processing device) may be considered to provide a redundant sub-system for providing a check on the analysis derived from image capture devices 122 and 124 (e.g., to provide an automatic emergency braking (AEB) system).

One of skill in the art will recognize that the above camera configurations, camera placements, number of cameras, camera locations, etc., are examples only. These components and others described relative to the overall system may be assembled and used in a variety of different configurations without departing from the scope of the disclosed embodiments. Further details regarding usage of a multi-camera system to provide driver assist and/or autonomous vehicle functionality follow below.

As will be appreciated by a person skilled in the art having the benefit of this disclosure, numerous variations and/or modifications can be made to the foregoing disclosed examples. For example, not all components are essential for the operation of system 100. Further, any component can be located in any appropriate part of system 100 and the components can be rearranged into a variety of configurations while providing the functionality of the disclosed embodiments. Therefore, the foregoing configurations are examples and, regardless of the configurations discussed above, system 100 can provide a wide range of functionality to analyze the surroundings of vehicle 200 and navigate vehicle 200 or alert a user of the vehicle in response to the analysis.

As discussed below in further detail and according to examples of the presently disclosed subject matter, system 100 may provide a variety of features related to autonomous driving, semi-autonomous driving, and/or driver assist technology. For example, system 100 can analyze image data, position data (e.g., global positioning system (GPS) location information), map data, speed data, and/or data from sensors included in vehicle 200. System 100 may collect the data for analysis from, for example, image acquisition unit 120, position sensor 130, and other sensors. Further, system 100 can analyze the collected data to determine whether or not vehicle 200 should take a certain action, and then automatically take the determined action without human intervention or it can provide a warning, alert or instruction which can indicate to a driver that a certain action needs to be taken. Automatic actions can be carried out under human supervision and can be subject to human intervention and/or override. For example, when vehicle 200 navigates without human intervention, system 100 may automatically control the braking, acceleration, and/or steering of vehicle 200 (e.g., by sending control signals to one or more of throttling system 220, braking system 230, and steering system 240). Further, system 100 can analyze the collected data and issue warnings and/or alerts to vehicle occupants based on the analysis of the collected data.

The following description refers to ASIL-D level—but it is applicable to other safety levels—including safety levels that differ from ASIL safety levels.

Safety Solutions

There is provided an integrated circuit such as but not limited to a system on chip that may address a number of dependent failures sources and aims at ensuring that no dependent failure exists between the integrated circuit elements considered independent. Thus, there is a provided an integrated circuit that includes computational paths that are redundant and comply with a certain ASIL level.

The computational paths may include a main path and at least one other redundant computational path. For simplicity of explanation, the main path and the at least one other redundant path are referred to as computational paths.

The system may include an integrated circuit that aims at implementing computational paths that are redundant. For simplicity of explanation it is assumed that there are two computational paths—although there can be more than two computational paths. Thus, the redundant computational paths may be in the same die, and in the same package.

A computational process executed by each of the computational paths may be related to driving and may include, for example, image processing, object detection, image distortion correction, control of an autonomous vehicle, determining or suggesting a future trajectory of a vehicle, performing any driver assistance process, and the like.

The computational results (also referred to as outputs) from the computational paths shall be sent to a comparator (also referred to as a selection unit). The comparator can be inside or outside the integrated circuit. The computational results may be the outputs of any of the processes that are related to driving.

In case the comparator is implemented within the same integrated circuit as the computational paths, an independency is maintained between the two computational paths and the comparator.

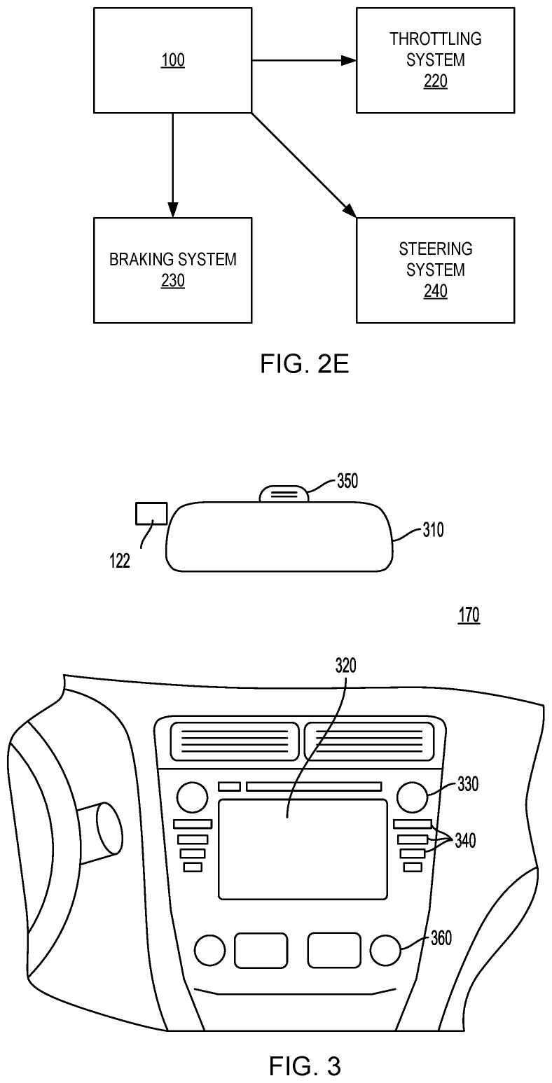

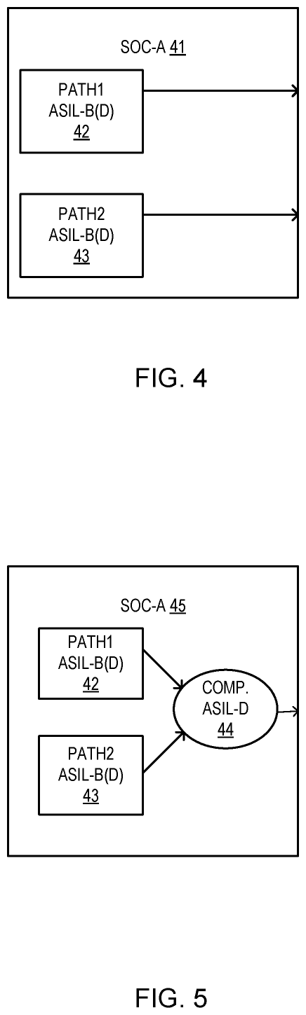

FIGS. 4 and 5 illustrate a single integrated circuit such as system on chip (SOC-A) 41 that includes two computational paths—a first computational path 42 that is ASIL-B(D) compliant, and a second computational path 43 that is ASIL-B(D) compliant. Both computational paths send their outputs to comparator 44 that is ASIL-D compliant.

Other safety levels (including not-ASIL safety levels) may be associated with the comparator, the first computational path and the second computational path. The comparator should be safer than each one of the SOCs.

In FIG. 4, the comparator is not shown—as it is located outside SOC-A 41. In FIG. 5 the comparator 44 is part of SOC-A 45.

The first computational path is assumed to be implemented on a hardware core (HW-IP) of a first type. The second computational path is assumed to be implemented on HW-IP of a second type. The second types may differ from each other by any measure illustrated below. For the sake of brevity of explanation, the explanation is limited to two types of cores although the approach can be repeated more than twice considering the opportunity to implement more than two independent channels within the same silicon.

According to the definition in ISO26262:2018, part 11, a dependent failure initiator (DFI) is a single root cause that leads multiple elements to fail through coupling factors.

The dependent failures have the ability to impair the results of any redundancy in the system and constitute thus a vulnerability.

The suggested integrated circuit prevents the propagation of the generic root cause via the different computational paths by performing at least one of the mentioned below solutions.

Some examples of the dependent failure initiators (DFIs) and the solutions that provide independent computational paths are illustrated in TABLE 1:

TABLE 1

| DFI and coupling mechanism | Solution |
|---|---|
| DFI - Coupling. Coupling | At least a hardware cores of different computational paths |
| mechanism - timing errors | have a separate clock source (oscillator). |
| (clock) | Different computational paths have separate dedicated clock |
| | distribution networks (PLL tree) |
| | Different computational paths have separate windowed |
| | watchdog. |
| | In case diverse oscillators are used for different |
| | computational paths, the diverse oscillators might be |
| | synchronized using dedicated devices (as an example an |
| | external watchdog) |
| DFI - Information exchange, | Every computational path has access to a dedicated bank of |
| coupling mechanism - access | external memory such as DRAM. |
| to memory | Every computational path has a diverse strategy for accessing |
| | physical memory (as an example diverse memory mapping) |
| | Every computational path might incorporate built in |
| | protections against memory data corruption in read and/or |
| | write operations. The built in protection may be, for example, |
| | a parity or cyclical redundancy checks on both memory |
| | address and data. |
| DFI - power, coupling | Every computational path has dedicated power rails |
| mechanism- power supply | The power rails might come from dedicated power supply |
| | lines for each computational path. |
| | The power rails might be monitored externally from the |
| | system under control according to the highest safety integrity |
| | required |
| DFI - functionality, coupling | Each computational path runs equivalent software (code), |
| mechanism- same | where equivalent means implementing the same functionality |
| functionality | The software in each computational path might be developed |
| | according to the highest safety integrity |
| | The two instances of SW executing in each of the |
| | computational path s are diverse (have same functionality, |
| | but diverse requirements, are developed and tested by |
| | different groups of people) |

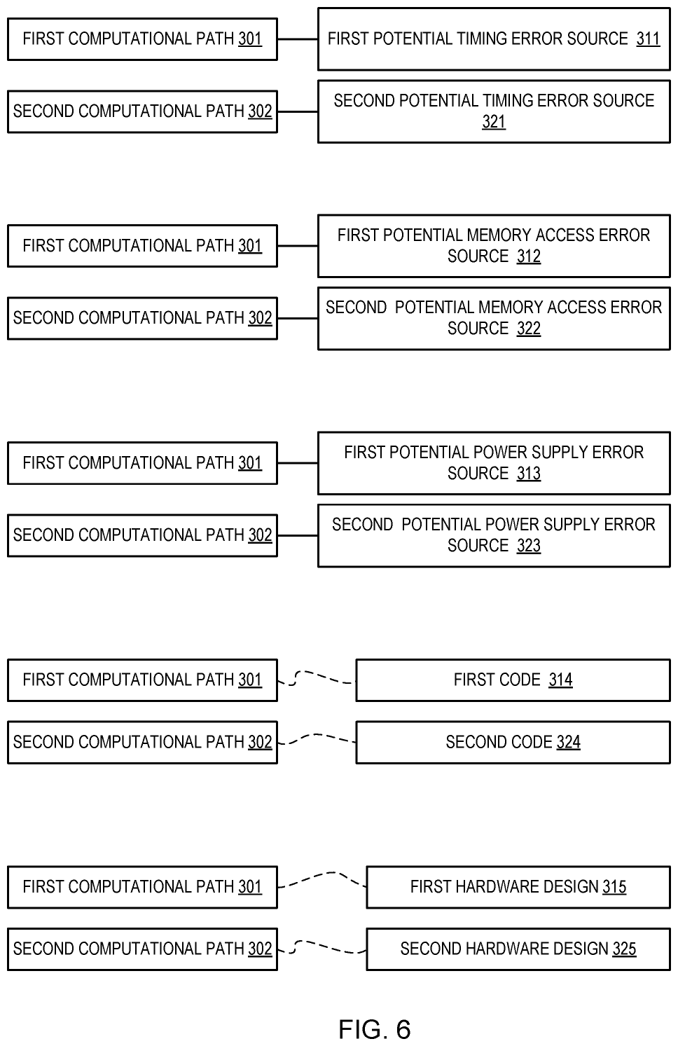

FIG. 6 illustrates examples of first computational path 301, second computational path 302, and various examples of solutions for preventing shared root errors.

The first computational path 301 and second computational path 302 may be connected to independent first and second potential timing error sources 311 and 321 respectively. The first and second potential timing error sources may be clock sources, clock distribution networks, oscillators, windowed watchdogs.

The first computational path 301 and second computational path 302 may be connected to independent first and second potential memory access error sources 312 and 322 respectively. The first and second potential memory access error sources may be memory units, memory addresses, parity units, and the like.

The first computational path 301 and second computational path 302 may be connected to independent first and second potential power supply error sources 313 and 323 respectively. The first and second potential power supply error sources may be power supply units, rails, power supply lines, and the like.

The first computational path 301 and second computational path 302 may execute independently developed codes. First computational path 301 may execute first code 314 and second computational path 302 may execute second code 324.

The first computational path 301 and second computational path 302 may exhibit different netlists and/or be of different hardware design—see first hardware design 315 of first computational path 301 and second hardware design 325 of second computational path 302.

Any combination of any of these solutions may be provided.

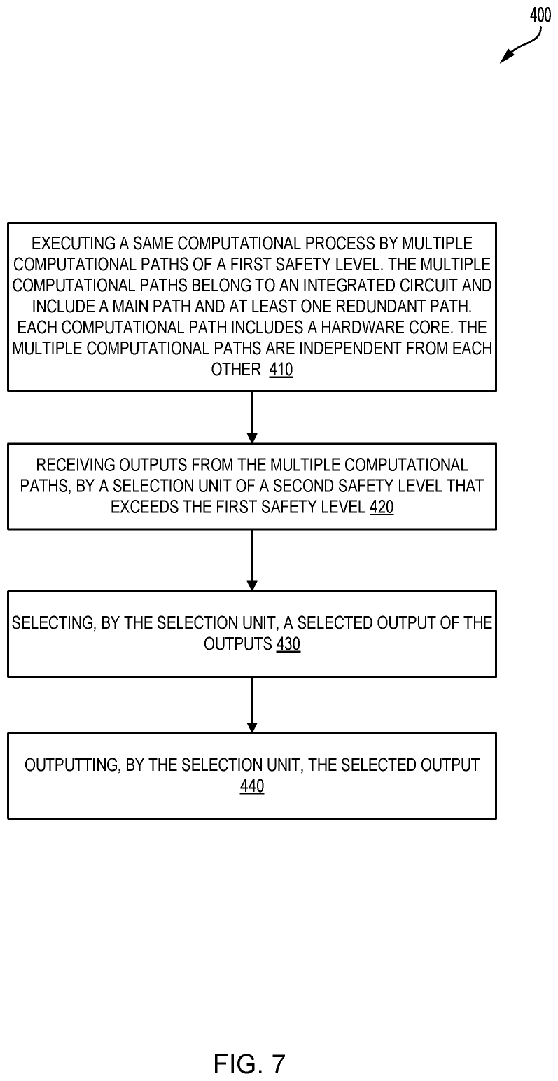

FIG. 7 is an example of method 400 for failure prevention.

Method 400 may include step 410 of executing a same computational process by multiple computational paths of a first safety level. The multiple computational paths belong to an integrated circuit and include a main computational path and at least one computational path . Each computational path includes a hardware core. The multiple computational paths are independent from each other. A hardware core may be a part of a processor (for example a central processing unit—CPU) and may perform operations (such as calculations). Multiple cores of a processor may work independently from each other or may cooperate with each other. CPUs that have more than a single hardware core may be referred to as multi-core CPUs.

Step 410 may be executed by the system illustrated in FIG. 4 or 5. The system may apply at least one of the measures listed in the table.

Step 410 may include executing, by different computational paths of the multiple computational paths, independently developed code. Thus- different computational paths may be configured to execute different codes that were independently developed.

Step 410 may include accessing, by different computational paths of the multiple computational paths, different memory regions.

Step 410 may include accessing, by different computational paths of the multiple computational paths, different memory units.

Step 410 may be followed by step 420 of receiving outputs from the multiple computational paths, by a selection unit of a second safety level that exceeds the first safety level.

The selection unit may belong to the integrated circuit or not.

Step 420 may be followed by step 430 of selecting, by the selection unit, a selected output of the outputs. The selection can be made in any manner, for example selecting a result from a computational path that seems to be more reliable, that may not be associated with a potential root cause.

Step 430 may be followed by step 440 of outputting, by the selection unit, the selected output.

Any reference to a system should be applied, mutatis mutandis to a method that is executed by a system and/or to a computer program product that stores instructions that once executed by the system will cause the system to execute the method. The computer program product is non-transitory and may be, for example, an integrated circuit, a magnetic memory, an optical memory, a disk, and the like.

Any reference to method should be applied, mutatis mutandis to a system that is configured to execute the method and/or to a computer program product that stores instructions that once executed by the system will cause the system to execute the method.

Any reference to a computer program product should be applied, mutatis mutandis to a method that is executed by a system and/or a system that is configured to execute the instructions stored in the computer program product.

The term “and/or” is additionally or alternatively.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

The phrase “may be X” indicates that condition X may be fulfilled. This phrase also suggests that condition X may not be fulfilled. For example—any reference to a system as including a certain component should also cover the scenario in which the system does not include the certain component.

The terms “including”, “comprising”, “having”, “consisting” and “consisting essentially of” are used in an interchangeable manner. For example, any method may include at least the steps included in the figures and/or in the specification, only the steps included in the figures and/or the specification. The same applies to the system and the mobile computer.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also, for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one as or more than one. Also, the use of introductory phrases such as “at least one ” and “one or more ” in the claims should not be construed to imply that the introduction of another claim element by the indefinite articles “a ” or “an ” limits any particular claim containing such introduced claim element to inventions containing only one such element, even when the same claim includes the introductory phrases “one or more ” or “at least one ” and indefinite articles such as “a ” or “an. ” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements the mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Any combination of any component of any component and/or unit of system that is illustrated in any of the figures and/or specification and/or the claims may be provided.

Any combination of any system illustrated in any of the figures and/or specification and/or the claims may be provided.

Any combination of steps, operations and/or methods illustrated in any of the figures and/or specification and/or the claims may be provided.

Any combination of operations illustrated in any of the figures and/or specification and/or the claims may be provided.

Any combination of methods illustrated in any of the figures and/or specification and/or the claims may be provided.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

We claim:

1. A safety system comprising an integrated circuit;
wherein the integrated circuit comprises multiple computational paths of a first safety level, the multiple computational paths configured to execute a same computational process and comprise a main path and at least one redundant path, each computational path comprising a hardware core, wherein the multiple computational paths are independent from each other; and
wherein the safety system further comprises a selection unit of a second safety level that exceeds the first safety level, wherein the selection unit is configured to receive outputs from the multiple computational paths, select a selected output of the outputs, and output the selected output.

2. The system according to claim 1, wherein the multiple computational paths do not share at least one root cause.

3. The system according to claim 1, wherein the multiple computational paths are fed by different clock sources.

4. The system according to claim 1, wherein the multiple computational paths are fed by different clock distribution networks.

5. The system according to claim 1, wherein the multiple computational paths are fed by different power supply units.

6. The system according to claim 1, wherein the multiple computational paths comprises different watchdogs.

7. The system according to claim 1, wherein the multiple computational paths have different netlists.

8. The system according to claim 1, wherein different computational paths of the multiple computational paths are independently designed.

9. The system according to claim 1, wherein different computational paths of the multiple computational paths are configured to execute independently developed code for executing the same computational process.

10. The system according to claim 1, wherein different computational paths of the multiple computational paths are configured to access different memory regions.

11. The system according to claim 1, wherein different computational paths of the multiple computational paths are configured to access different memory units.

12. A method for failure prevention, comprising:
executing a same computational process by multiple computational paths of a first safety level, the multiple computational paths belong to an integrated circuit and comprise a main path and at least one redundant path, each computational path comprises a hardware core, wherein the multiple computational paths are independent from each other;
receiving outputs from the multiple computational paths, by a selection unit of a second safety level that exceeds the first safety level;
selecting, by the selection unit, a selected output of the outputs; and
outputting, by the selection unit, the selected output.

13. The method according to claim 12, wherein the multiple computational paths do not share at least one root cause.

14. The method according to claim 12, wherein the multiple computational paths are fed by different clock sources.

15. The method according to claim 12, wherein the multiple computational paths are fed by different clock distribution networks.

16. The method according to claim 12, wherein the multiple computational paths are fed by different power supply units.

17. The method according to claim 12, wherein the multiple computational paths comprises different watchdogs.

18. The method according to claim 12, wherein the multiple computational paths have different netlists.

19. The method according to claim 12, wherein different computational paths of the multiple computational paths are independently designed.

20. The method according to claim 12, wherein the executing of the same computational process comprises executing independently developed code by different computational paths of the multiple computational paths.

21. The method according to claim 12, wherein the executing of the same computational process comprises accessing, by different computational paths of the multiple computational paths, different memory regions.

22. The method according to claim 12, wherein the executing of the same computational process comprises accessing, by different computational paths of the multiple computational paths, different memory units.

23. A non-transitory computer readable medium that stores instructions for:
executing a same computational process by multiple computational paths of a first safety level, the multiple computational paths belong to an integrated circuit and comprise a main path and at least one redundant path, wherein the multiple computational paths are independent from each other;
receiving outputs from the multiple computational paths, by a selection unit of a second safety level that exceeds the first safety level;
selecting, by the selection unit, a selected output of the outputs; and
outputting, by the selection unit, the selected output.
